(19) United States
(12) Patent Application Publication
(10) Pub. No.: US 2021/0182105 A1
(43) Pub. Date: Jun. 17, 2021

(54) Enhanced Resource Planning and Coordination

(71) Applicant: SAP SE, Walldorf (DE)

(72) Inventor: Deng Feng Wan, Shanghai (CN)

(21) Appl. No.: 16/711,059

(22) Filed: Dec. 11, 2019

(51) Int. Cl. G06F 9/50; G06F 9/46

(52) U.S. Cl. CPC G06F 9/5011; G06F 9/466

(57) ABSTRACT

Data is received that encapsulates each of a plurality of resource requests that each specify a time interval and a requested resource. Thereafter, an array can be generated that includes a plurality of elements such that, for each request, there is a first element corresponding to the start time and a second element corresponding to the end time. The array can then be time sorted and after such sorting the array can be iterated through to identified, for each element in the array, a number of overlapping requests to generate a respective request count. Elements of the array can be updated based on the iterating to include the respective request counts. A capacity balance is then calculated for each element in the array based on available resource capacity and the corresponding respective request count. Data can then be provided that indicates capacity consumption levels for each requested time interval.

### TECHNICAL FIELD

The subject matter described herein relates to enhanced systems for resource planning and coordination in which capacity varies over time intervals.

### BACKGROUND

Resource planning is a critical function of companies in diverse fields including transportation resources, warehouse and supply chain management, as well as work load/workforce planning. Such resource planning can involve a computer-based planning system which receives and manages requests for resources received from a large number of client computing devices. The processes required to identify resource capacity and to allocate or de-allocate capacity can consume significant amounts of computing resources such as memory, CPU usage, and network I/O.

### SUMMARY

Data can be received by way of at least one computing network that encapsulates each of a plurality of resource requests. Each resource request can specify a time interval having a start time and an end time and a requested resource. Thereafter, an array can be generated that includes a plurality of elements such that, for each request, there is a first element corresponding to the start time and a second element corresponding to the end time. The array can then be time sorted and after such sorting the array can be iterated through to identified, for each element in the array, a number of overlapping requests to generate a respective request count. Elements of the array can be updated based on the iterating to include the respective request counts. A capacity balance is then calculated for each element in the array based on available resource capacity and the corresponding respective request count. Data can then be provided that indicates capacity consumption levels for each requested time interval.

Providing the output can include one or more of: displaying the data, transmitting the data to a remote computing system over a computer network, loading the data into memory, or persisting the data in physical disk storage.

Based on the provided data, capacity for the requested resource can be selectively allocated or de-allocated during the corresponding requested time intervals. For example, availability of the resource can be automatically adjusted at one or more of the time intervals to accommodate all of the corresponding requests. The automatic adjusting can be initiated over a computing network by a resource planning system comprising at least one data processor and memory.

The resource requests can originate at a plurality of client computing devices coupled to the resource planning system via one or networks.

The requested resource can take various forms including, for example, a vehicle (for transportation applications), worker capacity, goods or manufacturing resources and the like.

Non-transitory computer program products (i.e., physically embodied computer program products) are also described that store instructions, which when executed by one or more data processors of one or more computing systems, cause at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The subject matter described herein provides many technical advantages. For example, the current subject matter provides more enhanced resource planning techniques and systems which consume fewer computing resources such as memory, CPU usage, and I/O.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is an example system diagram illustrating a resource planning system interacting with a plurality of clients each requesting resources (some of which have varying capacity) over different time intervals;

FIG. 2 is a diagram illustrating an arrangement in which resource capacity varies for different time intervals;

FIG. 3 is a diagram illustrating an arrangement for handling concurrent requests for resources;

FIG. 4 is a diagram illustrating restructuring of time intervals into an array;

FIG. 5 is a diagram illustrating sorting of an array according to value;

FIGS. 6A-6F are diagrams illustrating looping through an array to calculate overlaps;

FIG. 7 is a diagram illustrating calculation of capacity count minus requests count for time intervals;

FIG. 8 is a first diagram illustrating delta request handling;

FIG. 9 is a second diagram illustrating delta request handling;

FIG. 10 is a third diagram illustrating delta request handling;

FIG. 11 is a fourth diagram illustrating delta request handling;

FIG. 12 is a process flow diagram illustrating enhanced resource planning and coordination;

FIG. 13 is a diagram illustrating aspects of a computing device for implementing the current subject matter.

Like reference symbols in the various drawings indicate like elements.

### DETAILED DESCRIPTION

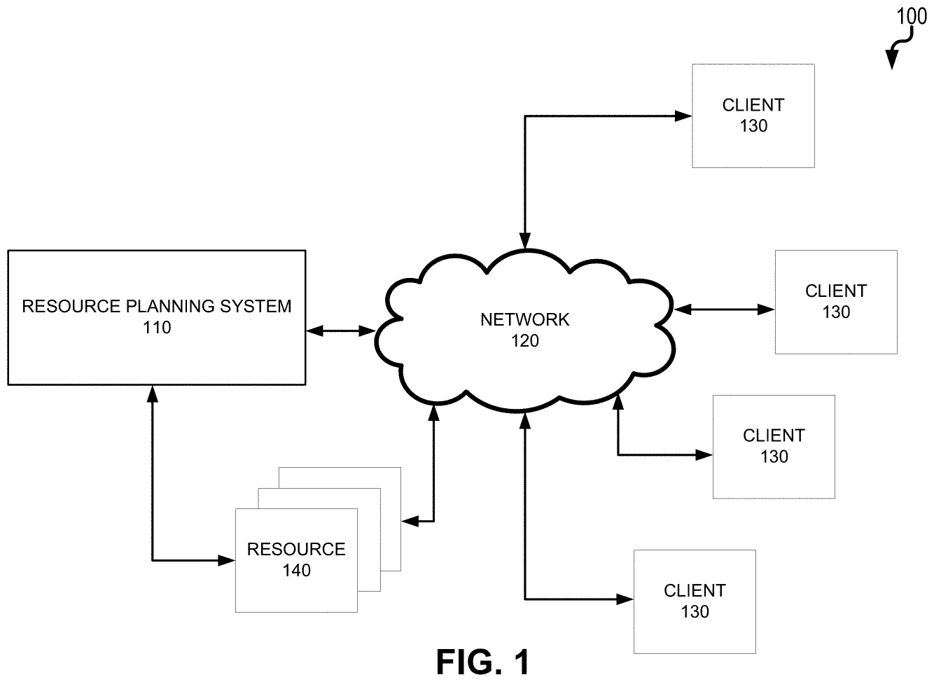

The current subject matter is directed to enhanced techniques for computer-based resource planning and coordination in which resources have limited and or varying capacity over time intervals. With reference to diagram 100 of FIG. 1, a resource planning system 110 (which can be, for example, one or more computing devices/servers, etc.) can interact with a plurality of clients 130 (i.e., desktop computers, mobile devices, tablets, etc.) by way of a network 120 (e.g., a local network, the Internet, etc.). The resource planning system 110 can also control or otherwise allocate availability of various resources 140. The resource planning system 110 can access or otherwise allocate the resources 140 directly or via a network 140. Furthermore, the client, in some cases, can access the resources 140 directly after allocation (not shown).

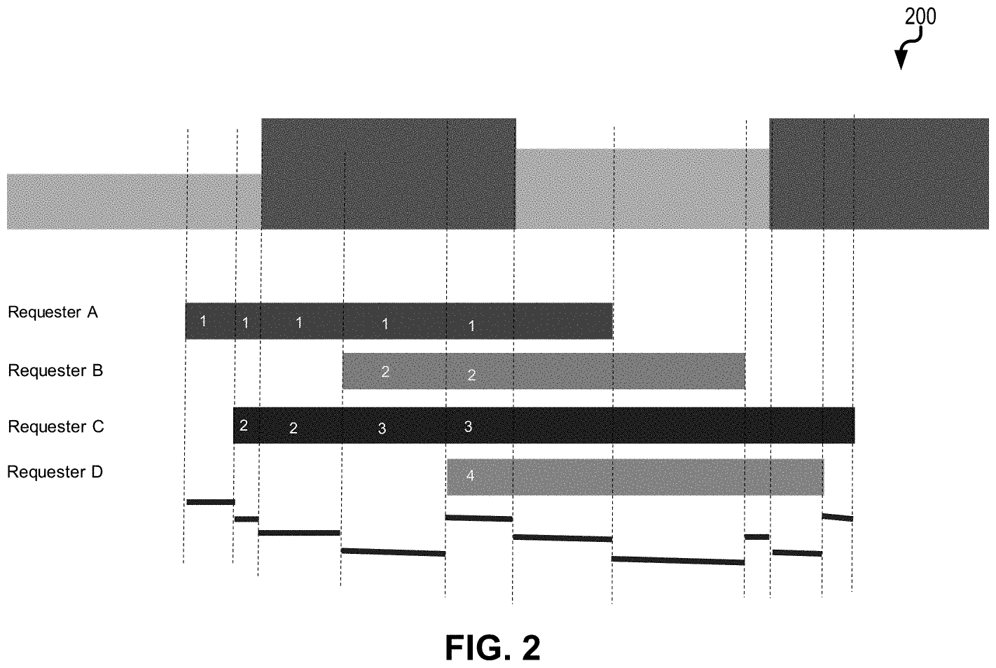

FIG. 2 is a diagram 200 illustrating an arrangement in which resource capacity varies for different time intervals (in which the heights at any given time interval indicate different capacity). As illustrated in FIG. 2, there are four requesters requesting certain resources (indicated by numbers) over different time intervals. Such requests originate from the clients 130 and are sent to the resource planning system 110 by way of the network 120.

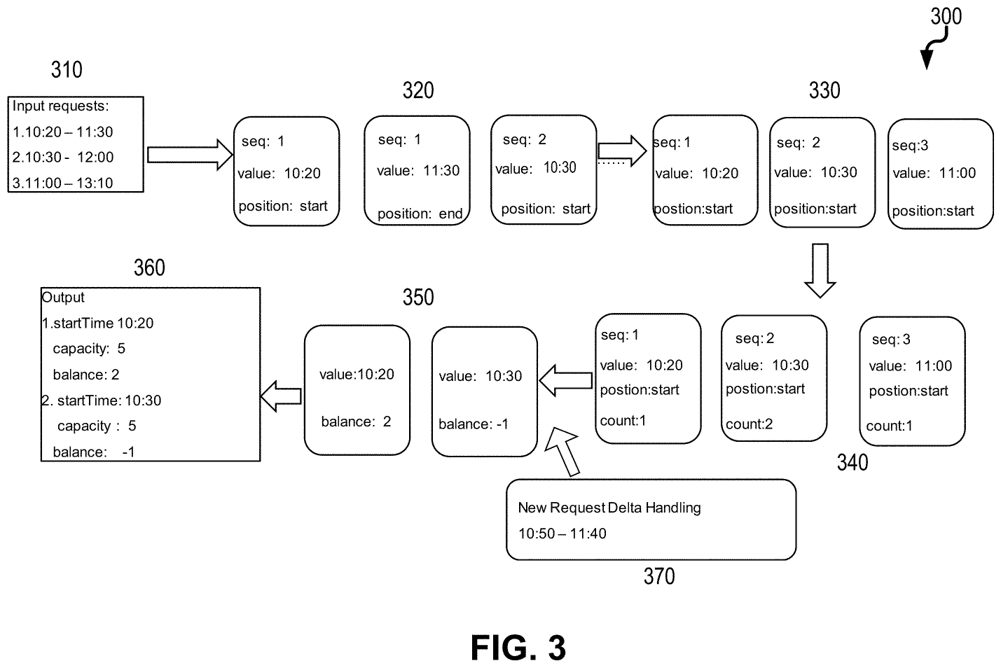

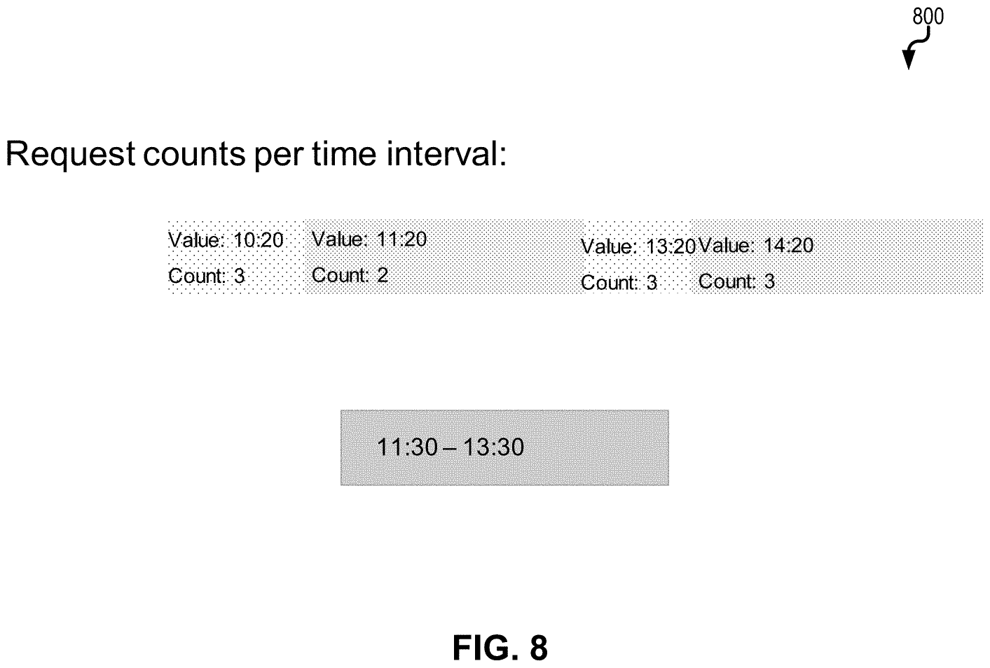

FIG. 3 is a diagram 300 illustrating how the resource planning system 110 handles concurrent requests for resources from various clients 130. In this example, data is received from three of the clients 130 that each encapsulate data requesting a resource for a corresponding input time interval (which are illustrated as input requests 310). At 320, the input time intervals are restructured to populate an array in which there is a corresponding entry for each start and end time for each request. Thereafter, at 330, the array is sorted according to only values, forget the position. After the array is sorted, at 340, the array is iterated through to count the overlaps in requests at each time. Overlap, in this regard, refers to the number of concurrent requests at each entry in the array (e.g., at 10:30 there are two requests for the resource and so the request count is 2). At each point in the array, at 350, the request count is compared to the available capacity for the corresponding resource to generate a capacity balance value. The output 360 of this process indicates available capacity at each requested start time. Similarly, the output 360 can optionally indicate available capacity at each requested end time. The output 360 can be used, for example, by the resource planning system 110 to allocate or deallocate the requested resource at the various requested time intervals. In some cases, the resource planning system 110 can also act to reschedule certain resource requests to a different time interval. Further, in some variations, at 370, an additional request for the resource is received over a different interval. The handling logic will be illustrated in FIG. 8, 9, 10, 11.

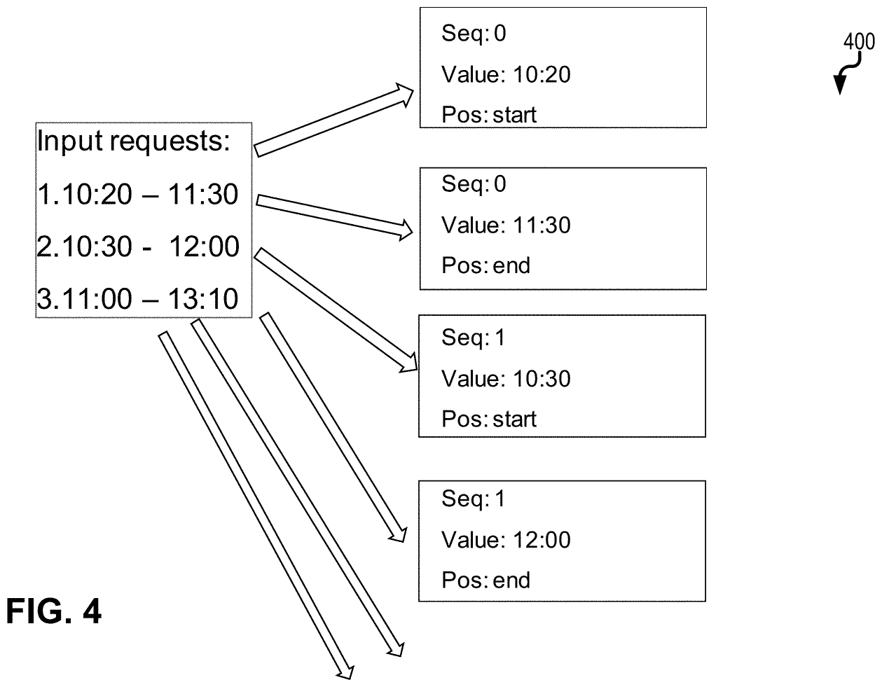

FIG. 4 is a diagram 400 illustrating further aspects of the restructuring of the time intervals to an array as in 320.

The following code illustrates one way to implement the restructuring of the time intervals:

for i=0 ; i < inputRequests length; i++
{

```
create a new elementA;
  elementA's sequence number = i ;
  elementA's value = start time;
  elementA's position = start;
  create a new elementB;
  elementB's sequence number = i ;
  elementB's value = start time;
  elementB's position = end;
  put both elements to array;
```

}

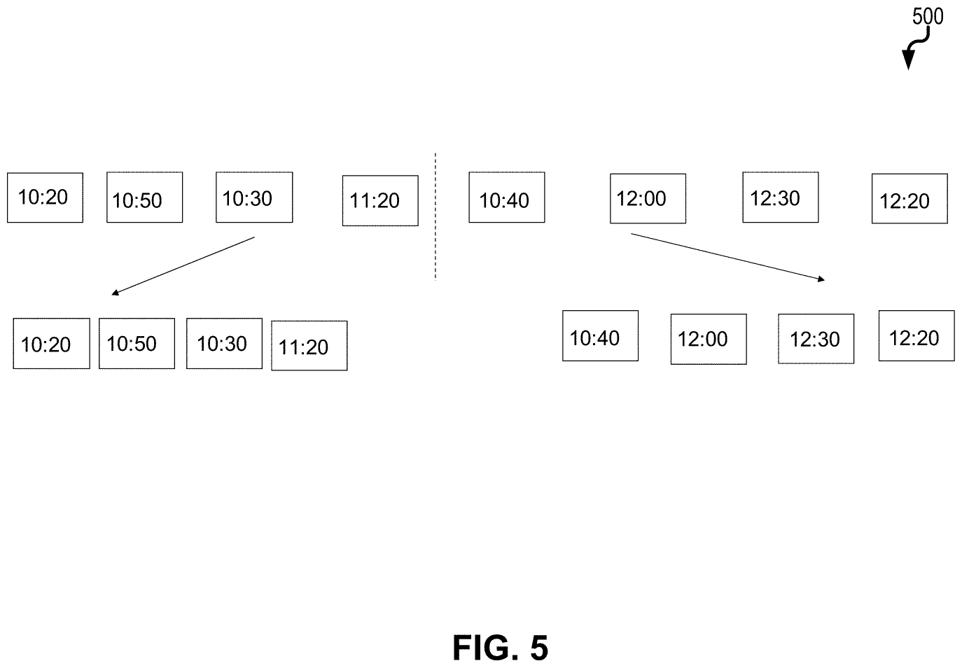

FIG. 5 is a diagram 500 illustrating further aspects of the sorting of the array according to the value only as in 330. The sorting can be performed using, for example, a merge sort algorithm which acts to break down a list into several sublists until each sublist consists of a single element and merging those sublists in a manner that results into a sorted list.

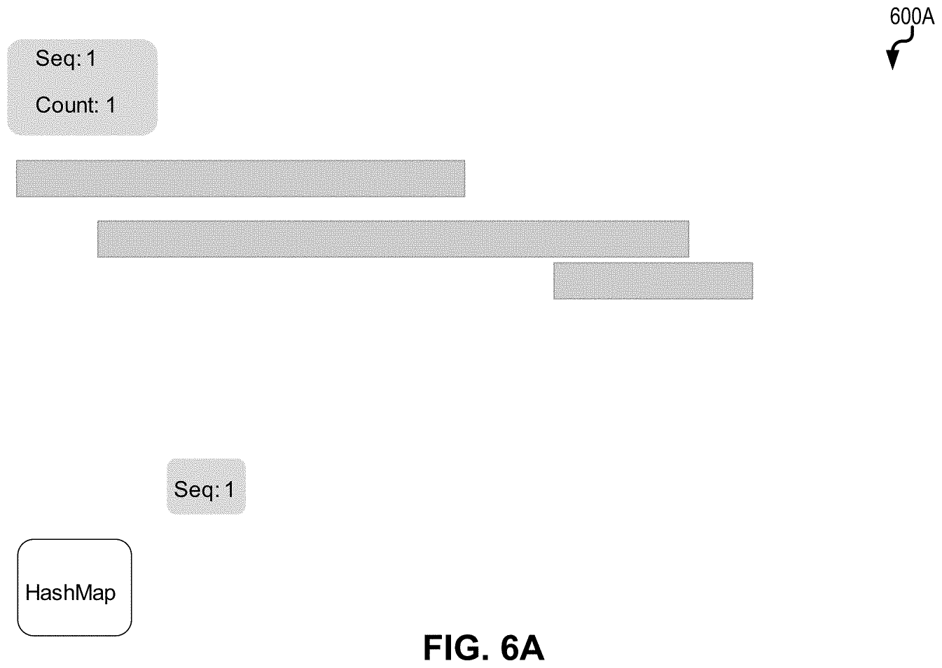

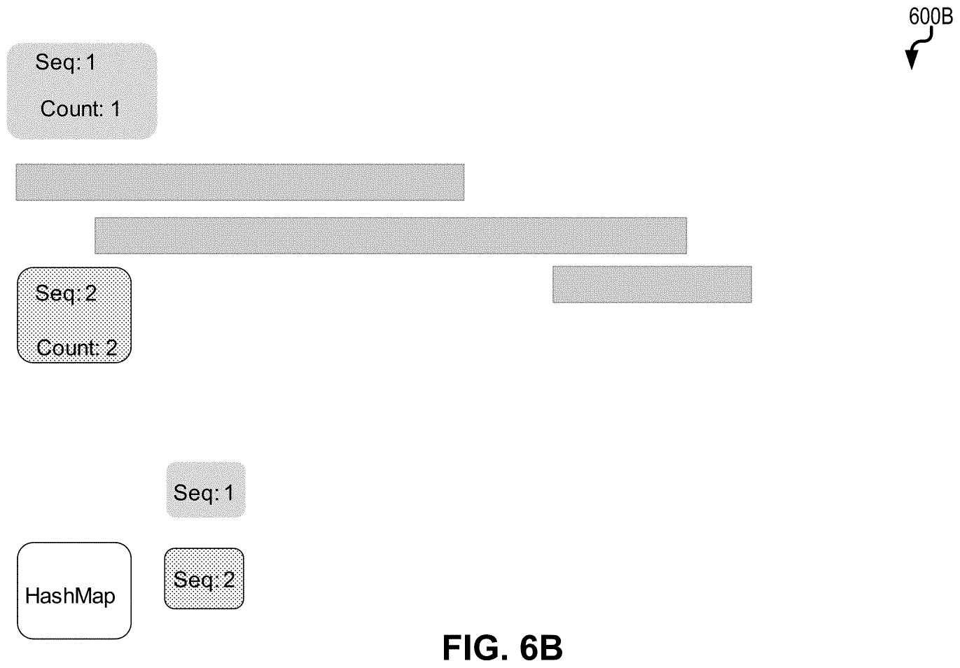

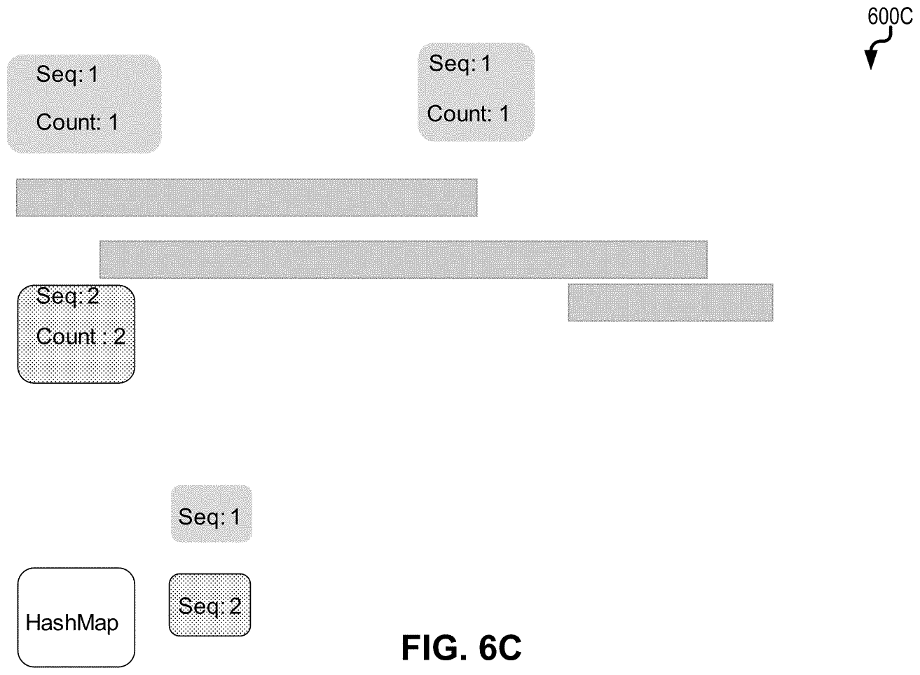

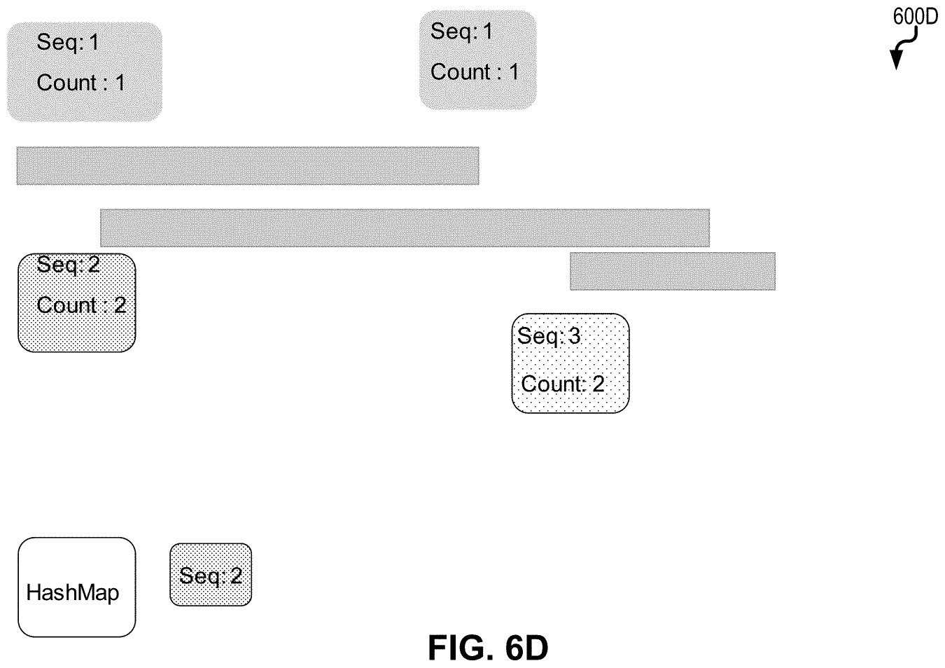

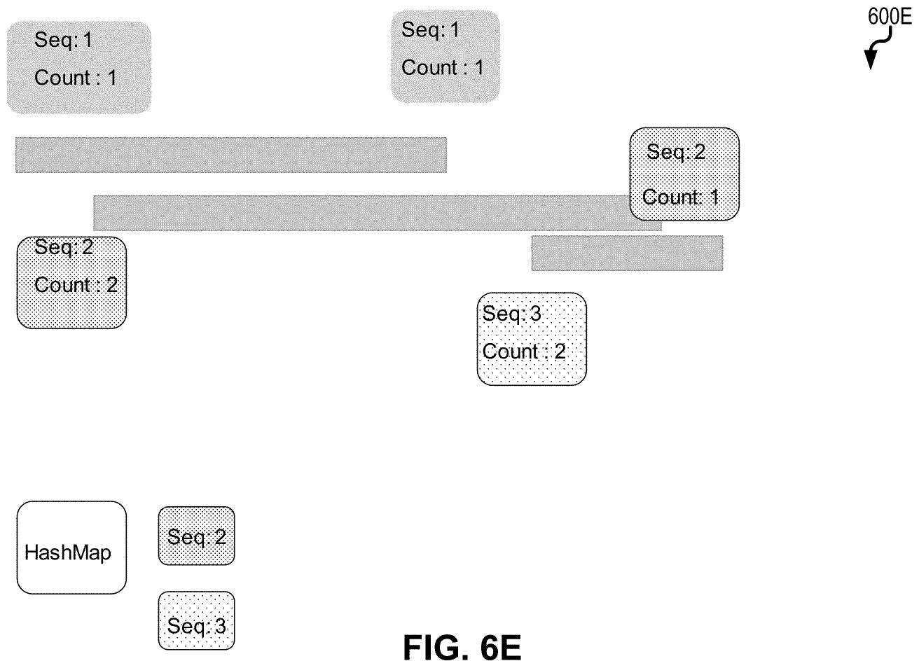

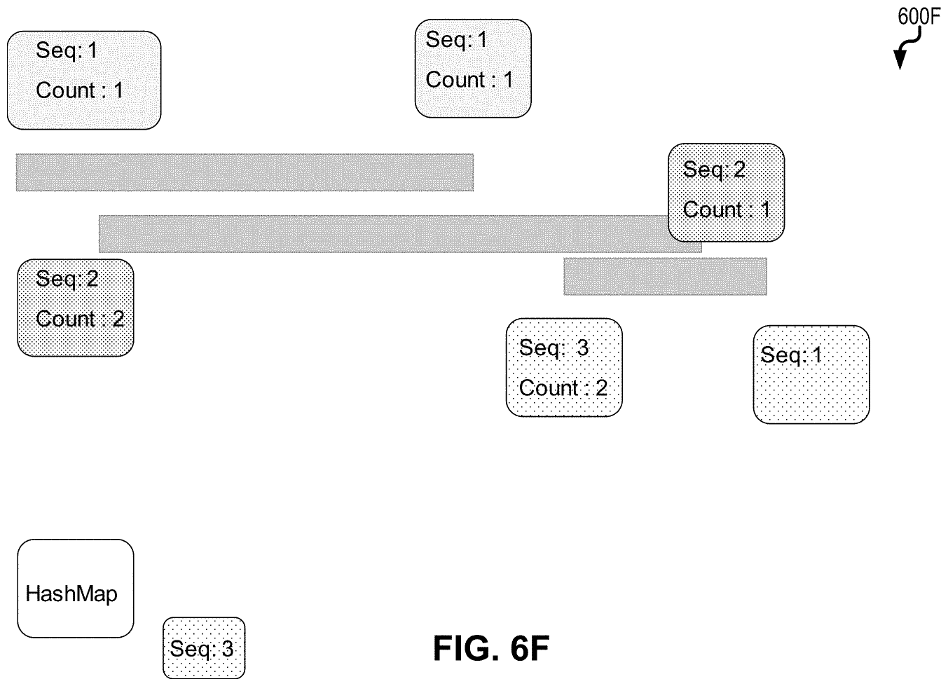

FIGS. 6A-F are diagrams 600A-F illustrating calculation of overlap times of the request as in 340. As will be noted in these figures, at each point in the array, the number of overlapping requests is calculated and used to update a corresponding value in a hashmap. While looping the sorted array with time, if meet next element which has a position as start time, it means there will be new request for this period, so we put current sequence number to hash map; if meet next element which has a position as end time, it means the resource request period is coming to an end for this time, so we remove the sequence number from hash map, and this period is calculated already, the overlap count is exactly the hashmap size.

Code:

for each element in the sorted array

if element's position is start then

put the element's seqs number to HashMap

```
  else if element's position is end then
    remove the element's seq number from HashMap.
  endif
```

element overlap overlap count = Hashmap size

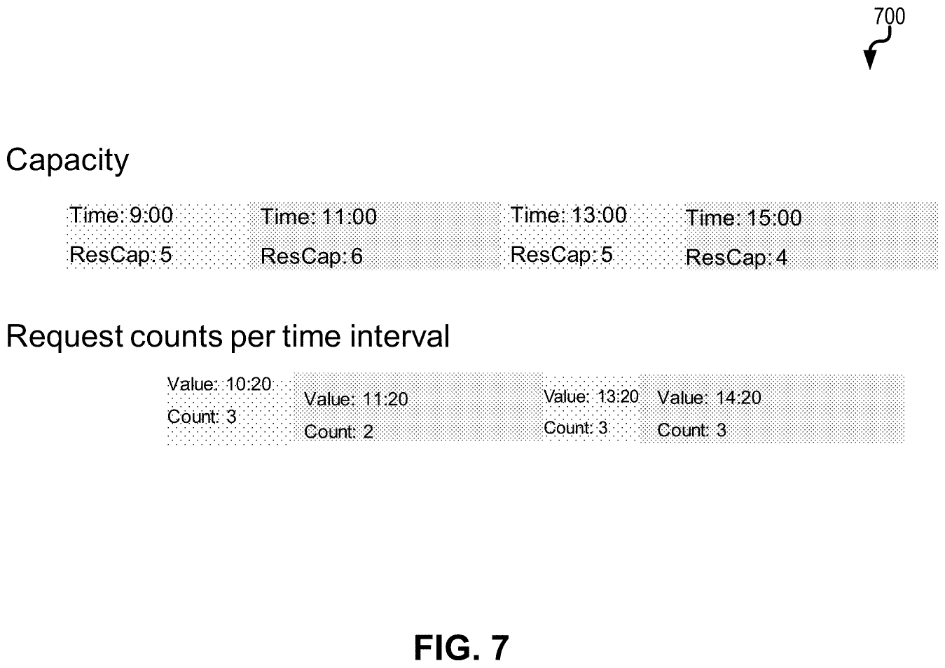

FIG. 7 is a diagram 700 illustrating capacity as compared to request counts per time interval as in operation 350.

Below is code for implementing a calculation for capacity count minus requests count for the time intervals of the request:

i=0; j=0; k=0; result[ ];
while (i< capacityArray's length; j < requestsTimeInterval array's
length;) {

if ( capacity element's value <= requests element's value) {

newEle's startTime =capacity element's startTime;
newEle's capacity = capacity element's capacity;
newEle's count = result array's last element's count. (k−1)
push the newEle to result array;

} else {

newEle's startTime =request element's startTime;
newEle's count = request element's count;
newEle's capacity = result array's last element's capacity. (k−1)
push the newEle to result array;

```
    }
  while ( i< capacityArray's length;) {
```

newEle's startTime =capacity element's startTime;
newEle's capacity = capacity element's capacity;
newEle's count = result array's last element's count. (k−1)
push the newEle to result array;

}
While (j< requestsArray's length) {

newEle's startTime =request element's startTime;
newEle's count = request element's count;
newEle's capacity = result array's last element's capacity. (k−1)
push the newEle to result array;

}

FIG. 8 is a diagram 800 illustrating new request delta handling as in operation 370. In particular, FIG. 8 illustrates that if a new request time interval is received, the process does not need to start over, rather, it can continue again from operation 340.

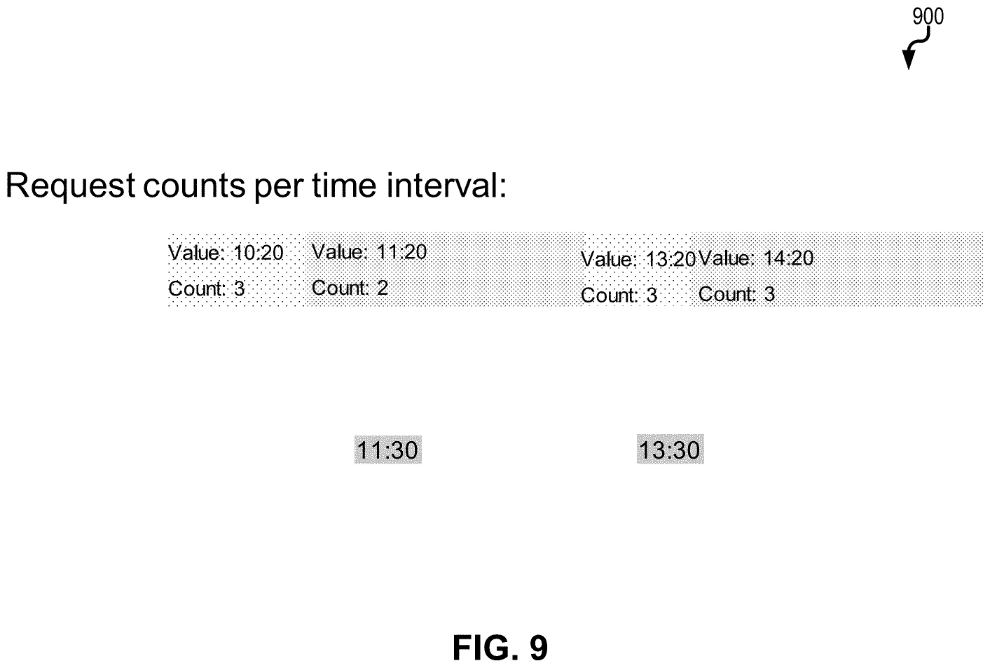

FIG. 9 is a diagram 900 in which binary search is used to find an insert position in the sorted array for the new time interval.

Example code for performing the binary search to find the appropriate insert position within the sorted array is as follows:

low = 0 high = array.length − 1;
while (low <= high) {

middle = Math.floor((low + high) / 2, 10);
element = array[middle];
if (element < value) {

low = middle + 1;

} else if (element > value) {

high = middle − 1;

} else {

break;
}

}
for (k = low; k < high; k++) {

if (value >= array[k] && value < array[k + 1]) {

return k;

}

}
//Found a value between [k] and [k+1], then k is the right
position for insertion.

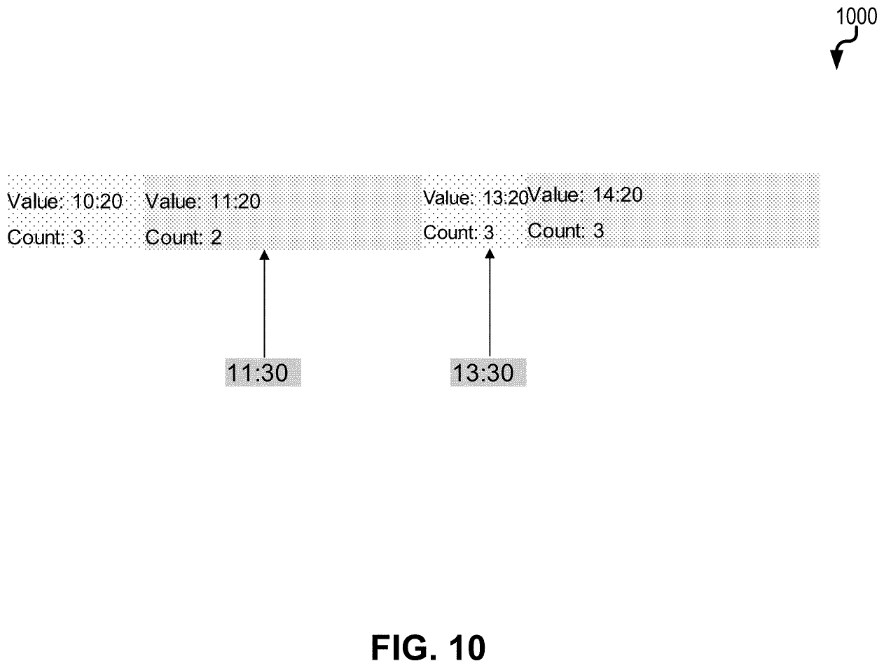

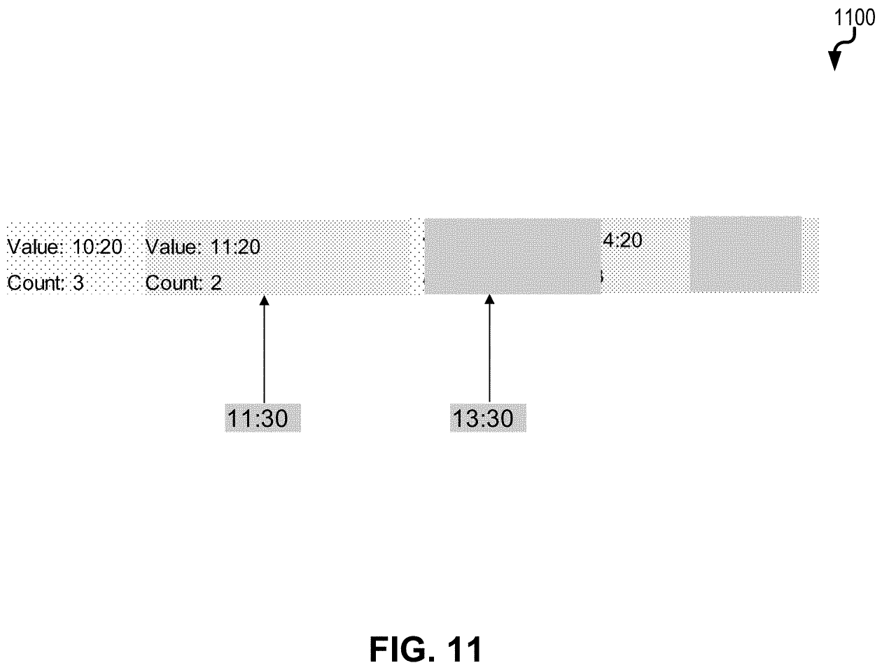

With regard to diagram 1000 of FIG. 10, once the insert position is located (for example, using the binary search option), two new elements (start time and end time interval) are inserted at the same time to increase efficiency. Diagram 1100 of FIG. 11 shows that after the newly added start time and end time intervals are added, there is a corresponding overlap time plus 1 because an additional overlap is added.

Example code for implementing the new request delta handling is as follows:

Add start time and end time to the original interval then count+1
for overlaps.
for (i=arrayLength+1; i>searchPositionStart; i−−) {

```
  if ( i > posEnd+2){
  //Move the element 2 places after
```

} else if ( I == posEnd+2) {

//Just put the new end element to that position

} else if (i in between posStart+1 and posEnd+2) {

//Move the element 1 place after. Then add each count +1

} else if (i==posStart+1) {

//Put the new start element to that position.

}

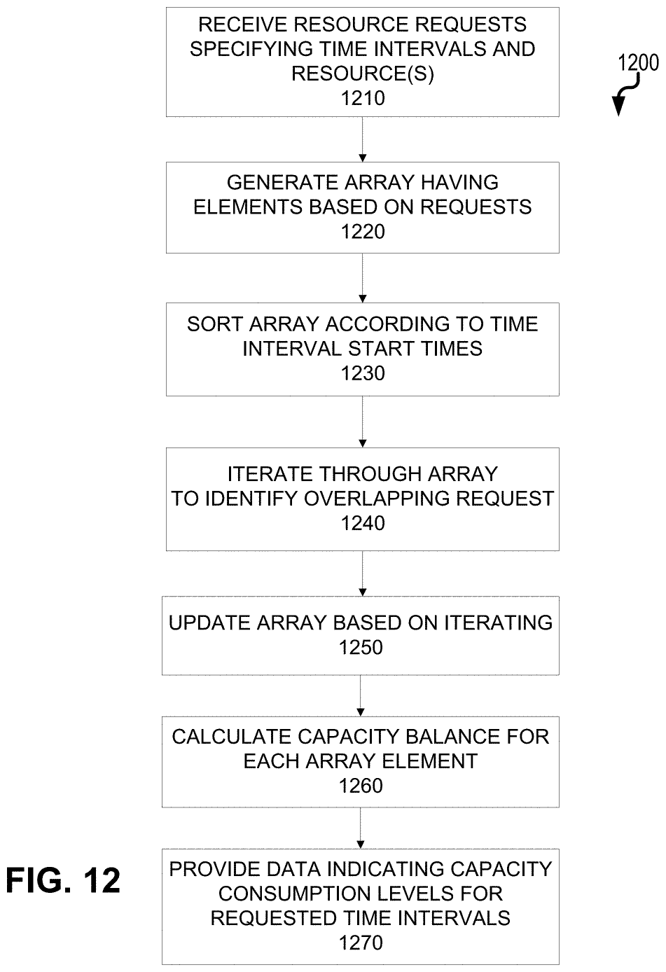

FIG. 12 is a process flow diagram in which, at 1210, data is received via at least one computing network that encapsulates each of a plurality of resource requests. Each resource request specifies (i) a time interval having a start time and an end time, and (ii) a requested resource. Thereafter, at 1220, an array is generated that includes a plurality of elements such that, for each request, there is a first element corresponding to the start time and a second element corresponding to the end time. The array is later, at 1230, sorted according to the start times. Next, at 1240, the array is iterated through to identify, for each element in the array, a number of overlapping requests to generate a respective request count. Elements of the array are updated, at 1250, to include the respective request counts. A capacity balance is calculated, at 1260, for each element in the array that is based on available resource capacity (during such time) and the corresponding respective request count. Subsequently, at 1270, data is provided indicating capacity consumption levels for each requested time interval.

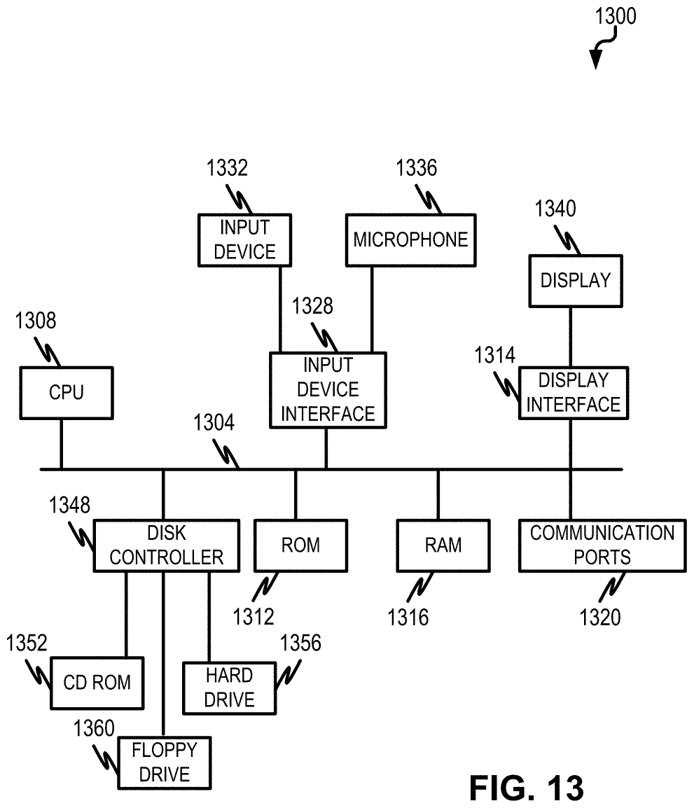

FIG. 13 is a diagram 1300 illustrating a sample computing device architecture for implementing various aspects described herein. A bus 1304 can serve as the information highway interconnecting the other illustrated components of the hardware. A processing system 1308 labeled CPU (central processing unit) (e.g., one or more computer processors/data processors at a given computer or at multiple computers), can perform calculations and logic operations required to execute a program. A non-transitory processor-readable storage medium, such as read only memory (ROM) 1312 and random access memory (RAM) 1316, can be in communication with the processing system 1308 and can include one or more programming instructions for the operations specified here. Optionally, program instructions can be stored on a non-transitory computer-readable storage medium such as a magnetic disk, optical disk, recordable memory device, flash memory, or other physical storage medium.

In one example, a disk controller 1348 can interface with one or more optional disk drives to the system bus 1304. These disk drives can be external or internal floppy disk drives such as 1360, external or internal CD-ROM, CD-R, CD-RW or DVD, or solid state drives such as 1352, or external or internal hard drives 1356. As indicated previously, these various disk drives 1352, 1356, 1360 and disk controllers are optional devices. The system bus 1304 can also include at least one communication port 1320 to allow for communication with external devices either physically connected to the computing system or available externally through a wired or wireless network. In some cases, the at least one communication port 1320 includes or otherwise comprises a network interface.

To provide for interaction with a user, the subject matter described herein can be implemented on a computing device having a display device 1340 (e.g., a CRT (cathode ray tube) or LCD (liquid crystal display) monitor) for displaying information obtained from the bus 1304 via a display interface 1314 to the user and an input device 1332 such as keyboard and/or a pointing device (e.g., a mouse or a trackball) and/or a touchscreen by which the user can provide input to the computer. Other kinds of input devices 1332 can be used to provide for interaction with a user as well; for example, feedback provided to the user can be any form of sensory feedback (e.g., visual feedback, auditory feedback by way of a microphone 1336, or tactile feedback); and input from the user can be received in any form, including acoustic, speech, or tactile input. The input device 1332 and the microphone 1336 can be coupled to and convey information via the bus 1304 by way of an input device interface 1328. Other computing devices, such as dedicated servers, can omit one or more of the display 1340 and display interface 1314, the input device 1332, the microphone 1336, and input device interface 1328.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer implemented method comprising:
receiving, via at least one computing network, data encapsulating each of a plurality of resource requests, each resource request specifying (i) a time interval having a start time and an end time, and (ii) a requested resource;
generating an array comprising a plurality of elements such that, for each request, there is a first element corresponding to the start time and a second element corresponding to the end time;
sorting the array according to the time interval;
iterating through the array to identify, for each element in the array, a number of overlapping requests to generate a respective request count;
updating, based on the iterating, elements of the array to include the respective request counts;
calculating, for each element in the array, a capacity balance based on available resource capacity and the corresponding respective request count; and
providing data indicating capacity consumption levels for each requested time interval.

2. The method of claim 1, wherein providing the output comprises at least one of: displaying the data, transmitting the data to a remote computing system over a computer network, loading the data into memory, or persisting the data in physical disk storage.

3. The method of claim 1 further comprising:
selectively allocating or de-allocating capacity for the requested resource during the requested time intervals based on the provided data.

4. The method of claim 1 further comprising:
automatically adjusting, based on the provided data, availability of the resource at one or more of the time intervals to accommodate all of the corresponding requests.

5. The method of claim 4, wherein the automatic adjusting is initiated over a computing network by a resource planning system comprising at least one data processor and memory.

6. The method of claim 5, wherein the resource requests are generated and originate at a plurality of client computing devices in communication with the resource planning system by way of the at least one computing network.

7. The method of claim 1, wherein the requested resource is a vehicle.

8. The method of claim 1, wherein the requested resource is worker capacity.

9. The method of claim 1, wherein the requested resource is a good utilized within a supply chain.

10. The method of claim 1, wherein the requested resource is an article of equipment.

11. A system comprising:
at least one data processor;
memory including instructions which, when executed by the at least one data processor, result in operations comprising:
receiving, via at least one computing network, data encapsulating each of a plurality of resource requests, each resource request specifying (i) a time interval having a start time and an end time, and (ii) a requested resource;
generating an array comprising a plurality of elements such that, for each request, there is a first element corresponding to the start time and a second element corresponding to the end time;
sorting the array according to the time interval;
iterating through the array to identify, for each element in the array, a number of overlapping requests to generate a respective request count;
updating, based on the iterating, elements of the array to include the respective request counts;
calculating, for each element in the array, a capacity balance based on available resource capacity and the corresponding respective request count; and
providing data indicating capacity consumption levels for each requested time interval.

12. The system of claim 11, wherein providing the output comprises at least one of: displaying the data, transmitting the data to a remote computing system over a computer network, loading the data into memory, or persisting the data in physical disk storage.

13. The system of claim 11, wherein the operations further comprise: selectively allocating or de-allocating capacity for the requested resource during the requested time intervals based on the provided data.

14. The system of claim 11, wherein the operations further comprise:
automatically adjusting, based on the provided data, availability of the resource at one or more of the time intervals to accommodate all of the corresponding requests.

15. The system of claim 14, wherein the automatic adjusting is initiated over a computing network by a resource planning system comprising at least one data processor and memory.

16. The system of claim 5, wherein the resource requests are generated and originate at a plurality of client computing devices in communication with the resource planning system by way of at least one network.

17. The system of claim 11, wherein the requested resource is a vehicle.

18. The system of claim 11, wherein the requested resource is worker capacity.

19. The system of claim 11, wherein the requested resource is an article of manufacturing equipment.

20. A non-transitory computer program product including instructions which, when executed by at least computing device, result in operations comprising:
receiving, via at least one computing network, data encapsulating each of a plurality of resource requests, each resource request specifying (i) a time interval having a start time and an end time, and (ii) a requested resource;
generating an array comprising a plurality of elements such that, for each request, there is a first element corresponding to the start time and a second element corresponding to the end time;
sorting the array according to the time interval;
iterating through the array to identify, for each element in the array, a number of overlapping requests to generate a respective request count;
updating, based on the iterating, elements of the array to include the respective request counts;
calculating, for each element in the array, a capacity balance based on available resource capacity and the corresponding respective request count; and
providing data indicating capacity consumption levels for each requested time interval.
